(19) United States
(12) Patent Application Publication
(10) Pub. No.: US 2024/0132027 A1
(43) Pub. Date: Apr. 25, 2024

(54) VEHICLE BRAKING SYSTEM

(71) Applicant: FACTION TECHNOLOGY, INC., South San Francisco, CA (US)

(72) Inventors: Ain MCKENDRICK, Redwood City, CA (US); Andrea MARIOTTI, Pacifica, CA (US); Mike LOWE, Santa Cruz, CA (US); Peter SCHMIDT, Fredericksburg, TX (US); Peter John DOYLE, Bozeman, MT (US)

(21) Appl. No.: 18/493,748

(22) Filed: Oct. 23, 2023

Related U.S. Application Data
(60) Provisional application No. 63/380,661, filed on Oct. 24, 2022.

(51) Int. Cl. B60T 7/12; B60T 13/74

(52) U.S. Cl. CPC B60T 7/12; B60T 13/745

(57) ABSTRACT

A vehicle braking system includes a processing device, a linear actuator, a master cylinder, and a braking caliper. The processing device is configured to receive a heartbeat from an operating vehicle. The linear actuator is communicatively coupled to the processing device. The master cylinder is coupled to the linear actuator. Upon not receiving the heartbeat within a threshold period of time, the processing device is configured to transmit a signal to the linear actuator to cause a force to be transmitted to the master cylinder, actuating the braking caliper, and causing the operating vehicle to stop.

### CROSS-REFERENCE TO RELATED APPLICATION

This application claims the benefit of and priority to U.S. Provisional App. No. 63/380,661 filed on Oct. 24, 2022. The 63/380,661 application is incorporated herein by reference.

### FIELD

The present disclosure is generally directed towards a vehicle braking system.

### BACKGROUND

Unless otherwise indicated herein, the materials described herein are not prior art to the claims in the present application and are not admitted to be prior art by inclusion in this section.

Vehicles are continually becoming more capable of driving autonomously without the input of a human operator. A continuing concern regarding autonomous vehicles is safety. Some autonomous vehicles may be configured to transmit electrical signals which may transmit commands to autonomous vehicle systems, including braking systems.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### BRIEF SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

In an embodiment, a vehicle braking system includes a processing device, a linear actuator, a master cylinder, and a braking caliper. The processing device is configured to receive a heartbeat from an operating vehicle. The linear actuator is communicatively coupled to the processing device. The master cylinder is coupled to the linear actuator. Upon not receiving the heartbeat within a threshold period of time, the processing device is configured to transmit a signal to the linear actuator to cause a force to be transmitted to the master cylinder, actuating the braking caliper, and causing the operating vehicle to stop.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### BRIEF DESCRIPTION OF THE DRAWINGS

Example embodiments will be described and explained with additional specificity and detail through the use of the accompanying drawings in which:

FIG. 1 illustrates an example vehicle;

FIG. 2 illustrates an example embodiment of a vehicle braking system that may be included in the vehicle of FIG. 1;

FIG. 3 illustrates a flow chart of an example method of emergency operation of the vehicle braking system of FIG. 2;

FIG. 4 illustrates a flow chart of an example method of a brake startup operation of the vehicle braking system of FIG. 2;

FIG. 5 illustrates a flow chart of an example method of an actuator startup operation of the vehicle braking system of FIG. 2;

FIG. 6 illustrates another example embodiment of a vehicle braking system that may be included in the vehicle of FIG. 1;

FIG. 7 illustrates a flow chart of an example method of emergency operation of the vehicle braking system of FIG. 6;

FIG. 8 illustrates a flow chart of an example method of a brake startup operation in a first configuration of the vehicle braking system of FIG. 6;

FIG. 9 illustrates a flow chart of an example method of a brake startup operation in a second configuration of the vehicle braking system of FIG. 6;

FIG. 10 illustrates a flow chart of an example method of an actuator startup operation of the vehicle braking system of FIG. 6;

FIG. 11A illustrates an example vehicle braking system using a spring that may be included in the vehicle of FIG. 1;

FIG. 11B illustrates an exploded view of the vehicle braking system of FIG. 11A;

FIG. 12 illustrates an example vehicle braking system using a single latch that may be included in the vehicle of FIG. 1;

FIG. 13 illustrates a sequence of operations associated with an enlarged portion of the vehicle braking system of FIG. 12;

FIG. 14 illustrates a sequence of operations associated with a vehicle braking system using a double latch;

FIG. 15 illustrates an enlarged perspective view of a portion of a vehicle braking system;

FIG. 16 illustrates another sequence of operations associated with a vehicle braking system using a double latch; and

FIG. 17 illustrates a block diagram of an example computing system.

### DESCRIPTION OF EMBODIMENTS

Vehicles may be used to transport persons and/or cargo. Some vehicles may include a processing device that may be configured to send electrical signals to various systems of the vehicle. For example, a vehicle may include steer by wire, drive by wire, brake by wire, and/or other systems that may be operated from controls received in electrical signals, e.g., from a processing device.

In some circumstances, issues may arise in a vehicle when electrical signals are no longer able to be communicated between systems of the vehicle. For example, a loss of power in the vehicle may reduce and/or prevent the transmission of electrical signals between the systems of the vehicle. An electrical failure in a moving vehicle may lead to undesirable results. As such, it may be beneficial to include backup, non-electrical systems, including braking systems, in a vehicle which may increase safety measures of the vehicle.

Some embodiments of a vehicle braking system described herein may facilitate emergency braking maneuvers for a vehicle, such as an autonomous vehicle, which may contribute to an increase in safety for the vehicle. For example, the vehicle braking system may be configured to function with existing braking elements of a vehicle. Alternatively, or additionally, the vehicle braking system may include additional braking elements that may be used in conjunction with existing braking systems and/or elements. In some embodiments, the vehicle braking system may be configured to cause a vehicle, such as an autonomous vehicle, to brake in instances in which the vehicle is experiencing certain triggering conditions.

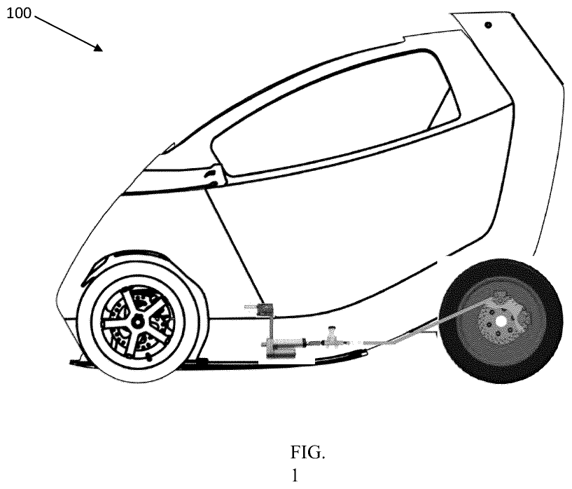

FIG. 1 illustrates an example vehicle 100 including a vehicle braking system, in accordance with at least one embodiment described in the present disclosure. The vehicle 100 may include an autonomous vehicle and/or a conventional vehicle, such as an automobile having a human operator. In general, the vehicle 100 may include any vehicle that includes a vehicle braking system, such as a brake system using disc brakes with calipers, drum brakes, or other brake systems. A vehicle described in the present disclosure may include any land vehicle such as motorcycles, which may include two-wheeled or three-wheeled variants, personal cars, trucks including semi-trucks, etc. Alternatively, or additionally, any vehicle described in the present disclosure may include an autonomous vehicle, such as a vehicle operated without direct input from an operator.

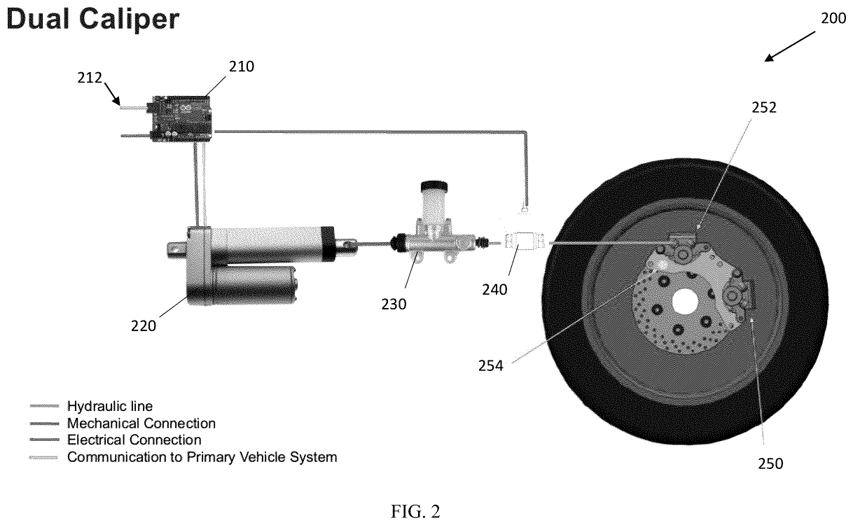

FIG. 2 illustrates an example embodiment of a vehicle braking system 200, in accordance with at least one embodiment described in the present disclosure. The vehicle braking system 200 may include a processing unit 210, a linear actuator 220, a master cylinder 230, a pressure sensor 240, a first caliper 250, a second caliper 252, and a speed sensor 254.

In some embodiments, the processing unit 210 may include code and routines configured to enable a computing system to perform or control performance of one or more operations. Alternatively, or additionally, the processing unit 210 may be implemented using hardware including a processor, a microprocessor (e.g., to perform or control performance of one or more operations), a field-programmable gate array (FPGA), or an application-specific integrated circuit (ASIC). In some other instances, the processing unit 210 may be implemented using a combination of hardware and software. In the present disclosure, operations described as being performed by the processing unit 210 may include operations that the processing unit 210 may direct a corresponding system to perform. Further, although described separately in the present disclosure to ease explanation of different operations performed and roles, in some embodiments, one or more portions of the processing unit 210 may be combined or part of the same module.

In some embodiments, the processing unit 210 may be configured to monitor a heartbeat 212 associated with the vehicle braking system 200. In some embodiments, the heartbeat may be determined from one or more input signals that may be received at an input signal line. In some embodiments, the heartbeat 212 may originate from an electrical system of the vehicle in which the vehicle braking system 200 is implemented. For example, a vehicle that includes the vehicle braking system 200 may include a main processing element that may be communicatively coupled with the processing unit 210.

In some embodiments, the heartbeat 212 may include one or more input signals such as a controller area network (CAN) bus signal, a transport control protocol (TCP) signal, an inter-integrated circuit (I2C) signal, an indication of main power from the vehicle, a main brake pressure signal, and/or other signals that may indicate a health status of the vehicle. In some embodiments, failing to receive one or more of the heartbeat 212 signals may indicate an emergency condition in which the processing unit 210 may be configured to cause actuation to the second caliper 252 (e.g., using the elements and methods of the vehicle braking system 200 as described below).

In some embodiments, the heartbeat 212 that is undetected by the processing unit 210 may cause the processing unit 210 to cause the second caliper 252 to be actuated, which may slow and/or stop one or more wheels associated with the vehicle braking system 200. Alternatively, or additionally, in instances in which the heartbeat 212 is detected by the processing unit 210, the processing unit 210 may continue to monitor the heartbeat 212 without making any changes to the vehicle braking system 200.

In some embodiments, the processing unit 210 may be communicatively coupled to the linear actuator 220. The processing unit 210 may be configured to transmit commands to the linear actuator 220 which may cause the linear actuator 220 to vary an output, such as described below.

In some embodiments, the processing unit 210 may be configured to receive input from the linear actuator 220 which may provide an indication to the processing unit 210 of the current state of the linear actuator 220. For example, the linear actuator 220 may be configured to notify the processing unit 210 that no force is currently applied, that a maximum force is currently applied, and/or any amount of force therebetween is currently applied. Alternatively, or additionally, the processing unit 210 may be configured to receive sensor input from the speed sensor 254.

In some embodiments, the processing unit 210 may be configured to vary the amount of force applied by the linear actuator 220 by varying the signal transmitted to the linear actuator 220 in view of the sensor data from the speed sensor 254. For example, in instances in which the second caliper 252 has fully stopped the associated wheel, but the vehicle still includes forward motion (e.g., the wheel has locked up as detected by the speed sensor 254 detecting no rotational motion of the wheel, but the vehicle is still moving), the processing unit 210 may transmit a signal to the linear actuator 220 to reduce the amount of force being applied, which may free the locked up wheel and improve the stopping of the vehicle.

In some embodiments, the processing unit 210 may be configured to receive power from the vehicle in which the vehicle braking system 200 is implemented. Alternatively, or additionally, the vehicle braking system 200 may include an independent power source (not pictured) which may provide power to at least the processing unit 210, the linear actuator 220, and the pressure sensor 240. In some embodiments, the independent power source may be configured to be recharged during use. For example, the independent power source may be coupled to the vehicle's alternator and/or an independent alternator such that the independent power source may be recharged.

In some embodiments, the processing unit 210 may be configured to store events that occur with respect to the vehicle braking system 200. For example, in instances in which the processing unit 210 no longer detects a heartbeat, the processing unit 210 may be configured to record and/or store sensor data (such as data from the linear actuator 220, the speed sensor 254, etc.) and/or the response of the elements of the vehicle braking system 200. Alternatively, or additionally, the processing unit 210 may be configured to transmit the recorded event and sensor data to an electronic control unit of the vehicle implementing the vehicle braking system 200. For example, the processing unit 210 may transmit recorded event and sensor data to an electronic control unit (ECU) of the vehicle. In some embodiments, the processing unit 210 may be configured to transmit the recorded event and sensor data to the ECU over a general-purpose input-output interface (GPIO). In some embodiments the GPIO may be associated with a controller that may include a GPS system.

In some embodiments, the processing unit 210 may be configured to cause the vehicle to perform actions in response to triggering conditions, which may include transmitting recorded event data, sensor data, and/or other transmissions. For example, the processing unit 210 may transmit recorded event and/or sensor data which may cause the vehicle to initiate vehicle hazard lights, provide a visual indicator to the operator of the vehicle status, begin broadcasting a GPS location, and/or other potential vehicle responses.

In some embodiments, the linear actuator 220 may be communicatively coupled with the processing unit 210. For example, the linear actuator 220 may be configured to receive an electronic signal from the processing unit 210. The electronic signal from the processing unit 210 may communicate one or more commands to control the operation of the linear actuator 220. For example, the processing unit 210 may transmit the electronic signal that may indicate that the vehicle braking system 200 is operating properly and that no change to the linear actuator 220 be taken. Alternatively, or additionally, the electronic signal from the processing unit 210 may cause the linear actuator 220 to apply a force.

In some embodiments, the linear actuator 220 may be configured to provide a feedback response to the processing unit 210. In some embodiments, the processing unit 210 may be configured to determine a current position of the linear actuator 220 based on the feedback response received from the linear actuator 220. For example, the linear actuator 220 may include a potentiometer configured to determine a current state of the linear actuator 220, which determination may be transmitted to the processing unit 210 as the feedback response. For example, the processing unit 210 may be configured to determine instances in which the position of the linear actuator 220 is fully open, fully closed, and/or any amount therebetween.

In some embodiments, the processing unit 210 may use the feedback response from the linear actuator 220 in conjunction with a determined speed of the vehicle and/or the speed of the wheel associated with the vehicle braking system 200. For example, in instances in which the processing unit 210 determines the vehicle should stop, the wheel is turning greater than a threshold speed, and the feedback response from the linear actuator 220 indicates the linear actuator 220 is open, the processing unit 210 may transmit a command to the linear actuator 220 to increase the force applied by the linear actuator 220.

In some embodiments, the linear actuator 220 may be coupled to the master cylinder 230. In some embodiments, the coupling between the linear actuator 220 and the master cylinder 230 may include a mechanical connection. For example, a screw, a rod, a chain, and/or other mechanical mechanisms may be included as the coupling between the linear actuator 220 and the master cylinder 230. In some embodiments, the linear actuator 220 may be configured to apply a force to the master cylinder 230.

In some embodiments, the master cylinder 230 may be configured to convert a received force into hydraulic pressure. For example, the master cylinder 230 may be configured to convert a received mechanical force from the linear actuator 220 into a hydraulic pressure. In some embodiments, the master cylinder 230 may be coupled to the second caliper 252. For example, the hydraulic output from the master cylinder 230 may be coupled to the second caliper 252. Alternatively, or additionally, the master cylinder 230 may be coupled to the pressure sensor 240.

In some embodiments, the pressure sensor 240 may be configured to determine a pressure in the hydraulic line from the master cylinder 230 to the second caliper 252. The determined pressure in the hydraulic line may contribute to determining the operability of the vehicle braking system 200 and the functionality of the vehicle braking system 200 under a triggering condition. For example, the processing unit 210 may obtain a determined pressure amount from the pressure sensor 240 in the hydraulic line where the processing unit 210 may determine the operability of the vehicle braking system 200, such as the master cylinder 230 not applying a force under non-triggering conditions or the master cylinder 230 applying a force in response to a triggering condition. In some embodiments, the triggering condition may include the processing unit 210 not receiving the heartbeat 212 within a threshold amount of time, e.g., within a threshold amount of time from a prior heartbeat 212. In another example, in response to the processing unit 210 not receiving the heartbeat 212 (e.g., within a threshold amount of time from a prior heartbeat 212), the processing unit 210 may obtain a determined pressure amount from the pressure sensor 240 and the processing unit 210 may use the determined pressure amount in determining the amount of force to be applied in a braking scenario.

In some embodiments, the first caliper 250 may include an original equipment manufacturer (OEM) caliper. For example, the first caliper 250 may include a caliper configured to provide braking to the vehicle in the absence of the vehicle braking system 200.

In some embodiments, the second caliper 252 may include a braking device that may be similar to the first caliper 250. For example, the second caliper 252 may be configured to stop the associated wheel from rotation upon receiving an applied force. In some embodiments, the second caliper 252 may be configured to be operated by the hydraulic pressure output from the master cylinder 230. In some embodiments, the second caliper 252 may be configured to be attached to the same rotor as the first caliper 250.

In some embodiments, the speed sensor 254 may be configured to determine a rotational speed of a wheel (such as the wheel illustrated in FIG. 2). The wheel may be associated with the first caliper 250 and the second caliper 252. In some embodiments, the determined speed from the speed sensor 254 may be obtained by the processing unit 210. In some embodiments, the determined speed from the speed sensor 254 may be used by the processing unit 210 to adjust an amount of braking applied by the second caliper 252. For example, the processing unit 210 may transmit a signal, based on the determined speed, to the linear actuator 220 to vary the amount of force delivered to the master cylinder 230, which may vary the amount of force applied by the second caliper 252.

Modifications, additions, or omissions may be made to the vehicle braking system 200 without departing from the scope of the present disclosure. For example, in some embodiments, the vehicle braking system 200 may include any number of other components that may not be explicitly illustrated or described.

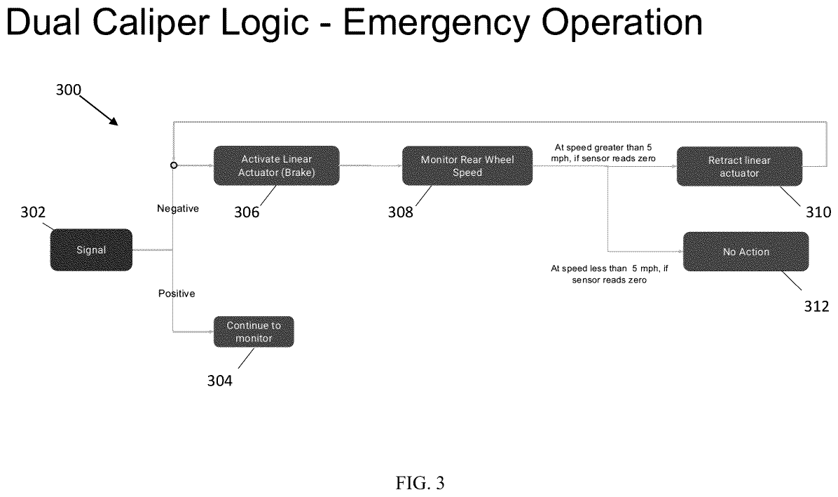

FIG. 3 illustrates a flow chart of an example method 300 of emergency operation of the vehicle braking system 200 of FIG. 2, arranged in accordance with at least one embodiment described in the present disclosure. Although illustrated as discrete blocks, various blocks may be divided into additional blocks, combined into fewer blocks, or eliminated, depending on the desired implementation.

In some embodiments, the method 300 may be configured to perform emergency operations associated with a vehicle braking system including dual calipers (e.g., the vehicle braking system 200 including first and second calipers 250, 254). For example, the vehicle braking system may activate an emergency brake, such as by actuating an emergency caliper (e.g., the second caliper 254 in some embodiments), in instances in which a heartbeat signal is no longer detected.

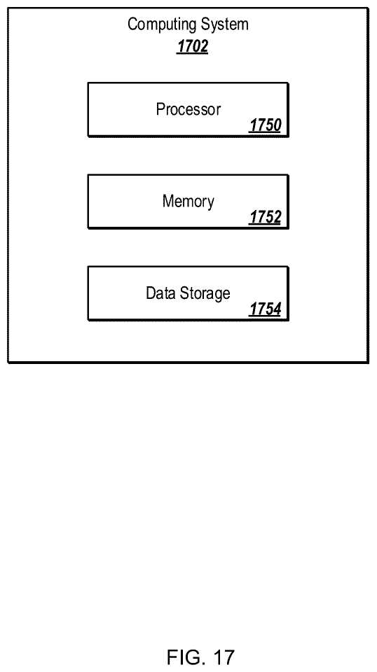

The method 300 may be performed by processing logic that may include hardware (circuitry, dedicated logic, etc.), software (such as is run on a general purpose computer system or a dedicated machine), or a combination of both, which processing logic may be included in the processing unit 210 of FIG. 2, the computing system 1702 of FIG. 17, or another computer system or device. However, another system, or combination of systems, may be used to perform the method 300.

For simplicity of explanation, methods described herein are depicted and described as a series of acts. However, acts in accordance with this disclosure may occur in various orders (not necessarily as illustrated) and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media.

In some embodiments, the method 300 may begin at block 302. At block 302, the processing logic may attempt to obtain a signal. For example, a signal line may be sampled to determine whether the signal is present or not present. Alternatively, or additionally, the processing logic may be configured to continually monitor the signal line such that each instance in which the signal is transmitted, the processing logic may observe and/or obtain the signal. In some embodiments, the signal may include a heartbeat signal as described relative to FIG. 2. For example, the signal may include a CAN bus signal, a TCP signal, an I2C signal, a main power signal, a main brake pressure signal, and/or other transmittable signals. In some embodiments, the processing logic may be configured to obtain the signal within a threshold period of time (e.g., from receipt of a prior signal). For example, the processing logic may be configured to sample the signal at a similar rate in which the signal is configured to be transmitted. For example, the processing logic may sample the signal approximately every one hundredth of a second.

In instances in which the processing logic determines the signal is present within the threshold period of time (e.g., from receipt of the prior signal), at block 304, the processing logic may determine no emergency operations be taken and may be configured to continue monitoring (e.g., reverting back to block 302).

In instances in which the processing logic determines the signal is not present within a threshold period of time, at block 306, the processing logic may be configured to apply an emergency brake. For example, the processing logic may cause an actuator, such as the linear actuator 220 of FIG. 2, to apply a force that may be configured to apply the emergency brake. In some embodiments, the processing logic may send a signal to the actuator to apply the emergency brake, which may include applying a maximum force to the emergency brake. Alternatively, or additionally, the processing logic may be configured to transmit a signal to the actuator that may cause any amount of force from the actuator to the emergency brake between no force and a maximum force.

At block 308, the processing logic may be configured to obtain a current speed of a wheel to which the emergency brake is affixed. For example, the processing logic may be configured to obtain the speed of the wheel from speed sensor data that may be generated by a speed sensor associated with the wheel having the emergency brake.

In instances in which the current speed of the wheel is zero or approximately zero and the speed of the associated vehicle is greater than a threshold speed (e.g., such as 5 miles per hour (MPH)), at block 310, the processing logic may be configured to transmit a signal to the actuator that may retract the actuator and/or reduce the amount of force created by the actuator. For example, in instances in which the vehicle is moving at a rate greater than 5 MPH and the speed sensor on the wheel indicates the wheel is not turning, the processing unit may be configured to cause the actuator to reduce the force applied to the emergency brake.

In some embodiments, after retracting the actuator at block 310, the processing logic may loop back to block 306, as illustrated in FIG. 3, and may be configured to cause the actuator to apply a force that may apply the emergency brake of the associated vehicle. For example, in instances in which the actuator was activated, the wheel speed was zero, the vehicle speed was greater than a threshold, and the actuator was fully or partially retracted, the processing logic may cause the actuator to be activated which may apply a force to the emergency brake. The operation performed by the processing logic may be similar or identical to operations performed with or for anti-lock brakes.

Alternatively, or additionally, after retracting the actuator at block 310, the processing logic may loop back to block 308, where the processing logic may continue to monitor the speed of the wheel. For example, after determining the wheel speed is zero and the associated vehicle speed is greater than a threshold (e.g., the wheel locked up and the associated vehicle still is moving faster than a threshold speed), the processing logic may cause the actuator to be partially retracted at block 310. The processing logic may continue to monitor the speed of the wheel, the speed of the associated vehicle, and may continue to perform emergency braking operations via making adjustments (e.g., completely or partially retracting or extending the actuator) to the force applied by the actuator.

In instances in which the current speed of the wheel is zero or approximately zero and the speed of the associated vehicle is less than the threshold speed, at block 312, the processing logic may determine that the amount of force generated by the actuator is adequate and that no further action relative to the actuator may be taken.

Modifications, additions, or omissions may be made to the method 300 without departing from the scope of the present disclosure. For example, in some embodiments, the method 300 may include a block that may follow block 308. In instances in which the current speed of the wheel is non-zero and the speed of the associated vehicle is greater than a threshold speed (e.g., such as 5 MPH), at the block following block 308, the processing logic may be configured to transmit a signal to the actuator that may maintain the state of actuator and/or maintain the amount of force applied by the actuator. Alternatively, or additionally, the processing logic may be configured to transmit a signal to the actuator that may extend the actuator and/or increase the amount of force applied by the actuator. In other examples, in some embodiments, the method 300 may include any number of other components that may not be explicitly illustrated or described.

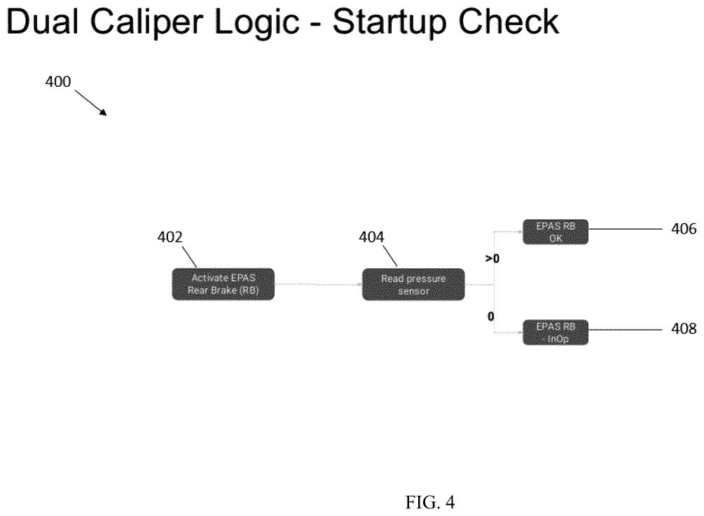

FIG. 4A illustrates a flow chart of an example method 400 of a brake startup operation of the vehicle braking system 200 of FIG. 2, arranged in accordance with at least one embodiment described in the present disclosure. Although illustrated as discrete blocks, various blocks may be divided into additional blocks, combined into fewer blocks, or eliminated, depending on the desired implementation.

In some embodiments, the method 400 may be configured to perform a startup check of a vehicle braking system, including performing a check on the OEM braking system. For example, upon startup of a vehicle, the vehicle braking system may perform an analysis to verify the OEM braking system is operational and/or the emergency braking system is operational.

The method 400 may be performed or controlled by processing logic that may include hardware (circuitry, dedicated logic, etc.), software (such as is run on a general purpose computer system or a dedicated machine), or a combination of both, which processing logic may be included in the processing unit 210 of FIG. 2, the computing system 1702 of FIG. 17, or another computer system or device. However, another system, or combination of systems, may be used to perform the method 400.

In some embodiments, the method 400 may begin at block 402. At block 402, the processing logic may cause the OEM brake to be applied. For example, the processing logic may transmit a signal to the OEM braking system to apply the OEM brakes.

At block 404, the processing logic may be configured to determine an amount of pressure applied by the OEM braking system. For example, the processing logic may be configured to obtain a sensed pressure value from a pressure sensor (e.g., such as the pressure sensor 240 of FIG. 2).

At block 406, the processing logic may determine that the sensed pressure value is greater than zero, and that the OEM braking system is operational. Alternatively, or additionally, the processing logic may determine the sensed pressure value is greater than a threshold amount, which may indicate the OEM braking system is operational.

At block 408, the processing logic may determine that the sensed pressure value is zero and that the OEM braking system is not operational. Alternatively, or additionally, the processing logic may determine the sensed pressure value is less than a threshold amount, which may indicate the OEM braking system is not operational.

Following block 406, 408, and/or other blocks of the method 400, the processing logic may be configured perform an analysis of the actuator that may be used in the emergency braking system, such as the linear actuator 220 of FIG. 2. For example, the processing logic may be configured to analyze the operability of the linear actuator.

Modifications, additions, or omissions may be made to the method 400 without departing from the scope of the present disclosure. For example, in some embodiments, the method 400 may include any number of other components that may not be explicitly illustrated or described.

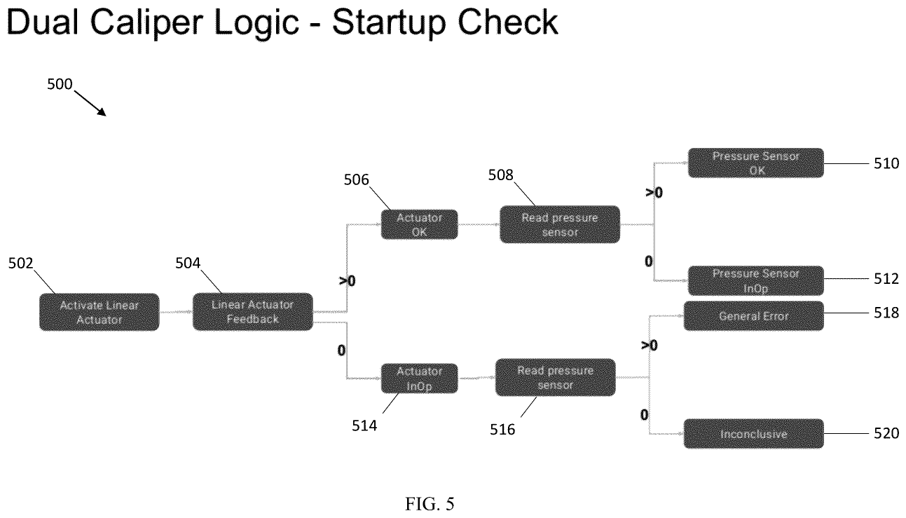

FIG. 5 illustrates a flow chart of an example method 500 of an actuator startup operation of the vehicle braking system 200 of FIG. 2, arranged in accordance with at least one embodiment described in the present disclosure. Although illustrated as discrete blocks, various blocks may be divided into additional blocks, combined into fewer blocks, or eliminated, depending on the desired implementation.

In some embodiments, the method 500 may be configured to perform a startup check of a vehicle braking system, including performing a check on the actuator that may be included therein. For example, upon startup of a vehicle, the vehicle braking system may perform an analysis to verify the actuator responds to inputs and produces output forces in response to the inputs.

The method 500 may be performed by processing logic that may include hardware (circuitry, dedicated logic, etc.), software (such as is run on a general purpose computer system or a dedicated machine), or a combination of both, which processing logic may be included in the processing unit 210 of FIG. 2, the computing system 1702 of FIG. 17, or another computer system or device. However, another system, or combination of systems, may be used to perform the method 500.

In some embodiments, the method 500 may begin at block 502. At block 502, the processing logic may be configured to actuate the actuator. For example, the processing logic may transmit a signal to the actuator that may cause the actuator to apply a force to the emergency brakes.

At block 504, the processing logic may be configured to obtain feedback from the actuator indicating the current status of the actuator. For example, the actuator may be configured to determine the status of the force applied and may be configured to provide that status to the processing logic upon request.

At block 506, the processing logic may be configured to determine the force applied by the actuator is greater than zero, and that the actuator is operational. Alternatively, or additionally, the processing logic may be configured to determine the force applied by the actuator is greater than a threshold amount, which may indicate the actuator is operational.

At block 508, the processing logic may be configured to determine an amount of pressure applied by the actuator. For example, the processing logic may be configured to obtain a sensed pressure value from a pressure sensor (e.g., such as the pressure sensor 240 of FIG. 2).

At block 510, the processing logic may determine that the sensed pressure value is greater than zero, and that the pressure sensor is operational. Alternatively, or additionally, the processing logic may be configured to determine the sensed pressure value is greater than a threshold amount, which may indicate the pressure sensor is operational. In some embodiments, in response to the processing logic determining the actuator and the pressure sensor are operational, the processing logic may determine the emergency braking system is operational.

At block 512, the processing logic may determine that the sensed pressure value is zero and that the pressure sensor is not operational. Alternatively, or additionally, the processing logic may determine the sensed pressure value is less than a threshold amount, which may indicate the pressure sensor is not operational.

At block 514, the processing logic may determine the force applied by the actuator is zero and that the actuator is not operational. Alternatively, or additionally, the processing logic may determine the force applied by the actuator is less than a threshold amount, which may indicate the actuator is not operational.

At block 516, the processing logic may be configured to determine an amount of pressure applied by the actuator. For example, the processing logic may be configured to obtain a sensed pressure value from a pressure sensor.

At block 518, the processing logic may determine that the sensed pressure value is greater than zero, which may indicate a general error in the emergency braking system. Alternatively, or additionally, the processing logic may determine the sensed pressure value is greater than a threshold amount, which may indicate a general error in the emergency braking system.

At block 520, the processing logic may determine the force applied by the actuator is zero, which may indicate the values of the actuator feedback and/or pressure sensor are inconclusive relative to the operability of the actuator. Alternatively, or additionally, the processing logic may determine the force applied by the actuator is less than a threshold amount, which may indicate the values of the actuator feedback and/or pressure sensor are inconclusive relative to the operability of the actuator.

Modifications, additions, or omissions may be made to the method 500 without departing from the scope of the present disclosure. For example, in some embodiments, the method 500 may include any number of other components that may not be explicitly illustrated or described.

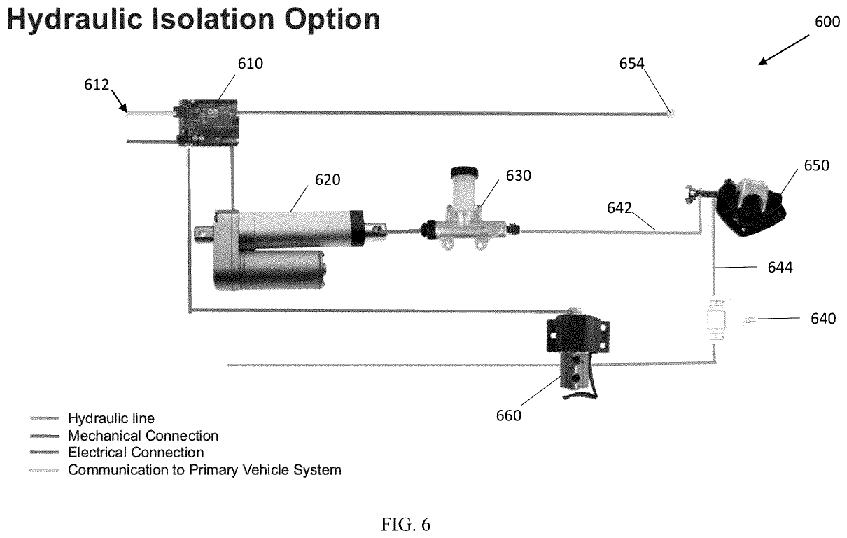

FIG. 6 illustrates an example embodiment of a vehicle braking system 600 that may be included in the vehicle 100 of FIG. 1, in accordance with at least one embodiment described in the present disclosure. The vehicle braking system 600 may include a processing unit 610, a heartbeat 612, a linear actuator 620, a master cylinder 630, a pressure sensor 640, an OEM caliper 650, a speed sensor 654, and a hydraulic isolator 660. In some embodiments, the vehicle braking system 600 and/or some or all of its associated elements may be analogous to the vehicle braking system 200 and/or its associated elements. For example, the processing unit 610, the heartbeat 612, the linear actuator 620, the master cylinder 630, and the speed sensor 654 may be analogous in structure and/or function to the processing unit 210, the heartbeat 212, the linear actuator 220, the master cylinder 230, and the speed sensor 254, respectively.

In some embodiments, the OEM caliper 650 may include multiple hydraulic line connections that may be used in the operation thereof. For example, the OEM caliper 650 may include the first hydraulic line 642 configured to provide typical braking functionality to the OEM caliper 650 and the second hydraulic line 644 configured to provide emergency braking functionality to the OEM caliper 650. Typical braking functionality may include responsive braking to a user depressing a brake pedal, a brake-by-wire signal to depress the brake pedal, etc., during operation of the vehicle. Emergency braking functionality may include braking provided by the vehicle braking system 600 in instances in which a triggering condition is detected, such as when the heartbeat 212 from the system is no longer present. The heartbeat 212 may include a CAN bus signal, a TCP signal, an I2C signal, a main power signal, a main brake pressure signal, and/or other transmittable signals.

In some embodiments, the first hydraulic line 642 may couple the master cylinder 630 to the OEM caliper 650. The operation of the first hydraulic line 642 may be controlled by one or more outputted signals from the processing unit 610 to control the linear actuator 620 and/or the master cylinder 630. For example, the processing unit 610 may transmit signals to the linear actuator 620 causing the linear actuator 620 to generate one or more forces therefrom. The one or more forces from the linear actuator 620 may be converted into a hydraulic pressure by the master cylinder 630, which may include the hydraulic pressure in the first hydraulic line 642.

In some embodiments, the second hydraulic line 644 may couple the pressure sensor 640 to the OEM caliper 650. Alternatively, or additionally, the second hydraulic line 644 may couple the OEM caliper 650 to the hydraulic isolator 660. In these and other embodiments, the second hydraulic line 644 may be operated by the braking system of the vehicle to which the vehicle braking system 600 is connected.

In some embodiments, the pressure sensor 640 may be included in the second hydraulic line 644. The pressure sensor 640 may be configured to measure a hydraulic pressure in the second hydraulic line 644. In some embodiments, the pressure sensor 640 may be configured to measure the hydraulic pressure in the first hydraulic line 642. For example, the hydraulic pressure in the second hydraulic line 644 from the vehicle braking system may be disabled (e.g., such as via the hydraulic isolator 660, as described below) and the pressure sensor 640 may be configured to measure the hydraulic pressure in the first hydraulic line 642. Alternatively, or additionally, more than one pressure sensor 640 may be included in the vehicle braking system 600. For example, a first pressure sensor may be included in the first hydraulic line 642 and a second pressure sensor may be included in the second hydraulic line 644. In some embodiments, the pressure sensor 640 may be communicatively coupled to the processing unit 610. The pressure sensor 640 may be configured to transmit the determined hydraulic pressure to the processing unit 610. In these and other embodiments, the processing unit 610 may be configured to determine the amount of pressure within the first hydraulic line 642 and/or the second hydraulic line 644 such as by using the measured hydraulic pressure from the pressure sensor 640.

In some embodiments, the hydraulic isolator 660 may be configured to restrict hydraulic pressure in the second hydraulic line 644. For example, the hydraulic isolator 660 may include a dual-state device. In some embodiments, the hydraulic isolator 660 may include a disabled state, which may include operation and/or control of the OEM caliper 650 by the braking system of the vehicle. Alternatively, or additionally, the hydraulic isolator 660 may include an enabled state, which may restrict operation and/or control of the OEM caliper 650 by the braking system of the vehicle. In some embodiments, the operation and/or control of the OEM caliper 650 in the enabled state may be controlled by the processing unit 610, the linear actuator 620, the master cylinder 630, and/or combinations thereof.

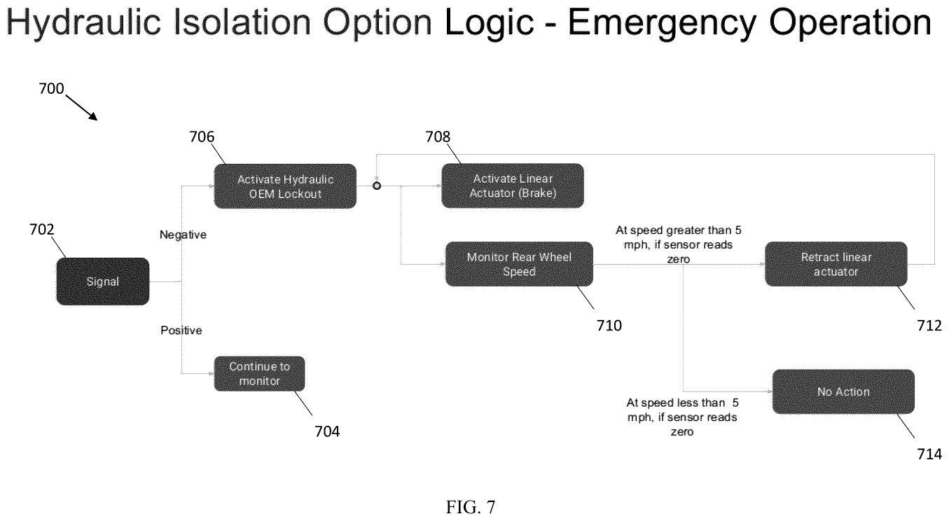

In some embodiments, the processing unit 610 may be configured to transmit a signal to the hydraulic isolator 660 which may control the state of the hydraulic isolator 660. In some embodiments, the state of the hydraulic isolator 660 may vary based on the processing unit 610 receiving the heartbeat 612. For example, in instances in which the processing unit 610 fails to receive the heartbeat 612 within a threshold period of time, the processing unit 610 may transmit a signal to the hydraulic isolator 660 which may cause the hydraulic isolator 660 to transition to the enabled state and allow emergency braking operations, as provided by the processing unit 610, to occur. The control of the hydraulic isolator 660 and emergency braking operations are further described relative to the method 700 of FIG. 7.

Modifications, additions, or omissions may be made to the vehicle braking system 600 without departing from the scope of the present disclosure. For example, in some embodiments, the vehicle braking system 600 may include any number of other components that may not be explicitly illustrated or described.

FIG. 7 illustrates a flow chart of an example method 700 of emergency operation of the vehicle braking system 600 of FIG. 6, arranged in accordance with at least one embodiment described in the present disclosure. Although illustrated as discrete blocks, various blocks may be divided into additional blocks, combined into fewer blocks, or eliminated, depending on the desired implementation.

In some embodiments, the method 700 may be configured to perform emergency operations associated with a vehicle braking system including a single caliper and hydraulic isolation. For example, the vehicle braking system may activate an emergency brake, such as by enabling the hydraulic isolator and actuating the caliper, in instances in which a heartbeat signal is no longer detected.

The method 700 may be performed by processing logic that may include hardware (circuitry, dedicated logic, etc.), software (such as is run on a general purpose computer system or a dedicated machine), or a combination of both, which processing logic may be included in the processing unit 210 of FIG. 2, the computing system 1702 of FIG. 17, or another computer system or device. However, another system, or combination of systems, may be used to perform the method 700.

In some embodiments, the method 700 may begin at block 702. At block 702, the processing logic may attempt to obtain a signal. For example, a signal line may be sampled to determine whether the signal is present or not present. Alternatively, or additionally, the processing logic may be configured to continually monitor the signal line such that each instance in which the signal is transmitted, the processing logic may observe and/or obtain the signal. In some embodiments, the signal may include a heartbeat signal as described relative to FIG. 2. For example, the signal may include a CAN bus signal, a TCP signal, an I2C signal, a main power signal, a main brake pressure signal, and/or other transmittable signals. In some embodiments, the processing logic may be configured to obtain the signal within a threshold period of time. For example, the processing logic may be configured to sample the signal at a similar rate in which the signal is configured to be transmitted. For example, the processing logic may sample the signal approximately every one hundredth of a second.

In instances in which the processing logic determines the signal is present within the threshold period of time, at block 704, the processing logic may determine no emergency operations be taken and may be configured to continue monitoring (e.g., reverting back to block 702).

In instances in which the processing logic determines the signal is not present within a threshold period of time, at block 706, the processing logic may be configured to actuate a hydraulic isolator. Actuating the hydraulic isolator may restrict the OEM braking system from controlling the caliper that may be used in the OEM braking system and/or the emergency braking system.

At block 708, the processing logic may be configured to activate the actuator, such that the actuator may apply an emergency brake. For example, the processing logic may cause an actuator, such as the linear actuator 220 of FIG. 2 to apply a force that may be configured to apply the emergency brake. In some embodiments, the processing logic may send a signal to the actuator to apply the emergency brake, which may include applying a maximum force to the emergency brake. Alternatively, or additionally, the processing logic may be configured to transmit a signal to the actuator that may cause any amount of force from the actuator to the emergency brake between no force and a maximum force. In some embodiments, the emergency brake may include the OEM braking system, such as the OEM caliper 650, that may be controlled by the processing unit 610 in an emergency situation.

At block 710, the processing logic may be configured to obtain a current speed of a wheel to which the emergency brake is affixed. For example, the processing logic may be configured to obtain the speed of the wheel from speed sensor data that may be generated by a speed sensor associated with the wheel having the emergency brake.

In instances in which the current speed of the wheel is zero or approximately zero and the speed of the associated vehicle is greater than a threshold speed (e.g., such as 5 miles per hour (MPH)), at block 712, the processing logic may be configured to transmit a signal to the actuator that may retract the actuator and/or reduce the amount of force created by the actuator. For example, in instances in which the vehicle is moving at a rate greater than 5 MPH and the speed sensor on the wheel indicates the wheel is not turning, the processing unit may be configured to cause the actuator to reduce the force applied to the brake that is functioning as an emergency brake.

In some embodiments, after retracting the actuator at block 712, the processing logic may loop back to block 708, as illustrated in FIG. 7, and may be configured to cause the actuator to apply a force that may apply the emergency brake of the associated vehicle. For example, in instances in which the actuator was activated, the wheel speed was zero, the vehicle speed was greater than a threshold, and the actuator was fully or partially retracted, the processing logic may cause the actuator to be activated which may apply a force to the emergency brake. The operation performed by the processing logic may be similar to anti-lock brakes.

Alternatively, or additionally, after retracting the actuator at block 712, the processing logic may loop back to block 710, where the processing logic may continue to monitor the speed of the wheel. For example, after determining the wheel speed is zero and the associated vehicle speed is greater than a threshold (e.g., the wheel locked up and the associated vehicle still is moving faster than a threshold speed), the processing logic may cause the actuator to be partially retracted at block 712. The processing logic may continue to monitor the speed of the wheel, the speed of the associated vehicle, and may continue to perform emergency braking operations via making adjustments (e.g., retracting the actuator) to the force applied by the actuator.

In instances in which the current speed of the wheel is zero or approximately zero and the speed of the associated vehicle is less than the threshold speed, at block 714, the processing logic may determine that the amount of force generated by the actuator is adequate and that no further action relative to the actuator may be taken.

Modifications, additions, or omissions may be made to the method 700 without departing from the scope of the present disclosure. For example, in some embodiments, the method 700 may include a block 716 that may follow block 710. In instances in which the current speed of the wheel is non-zero and the speed of the associated vehicle is greater than a threshold speed (e.g., such as 5 MPH), at block 716, the processing logic may be configured to transmit a signal to the actuator that may maintain the state of actuator and/or maintain the amount of force created by the actuator. Alternatively, or additionally, the processing logic may be configured to transmit a signal to the actuator that may extend the actuator and/or increase the amount of force created by the actuator. In other examples, in some embodiments, the method 700 may include any number of other components that may not be explicitly illustrated or described.

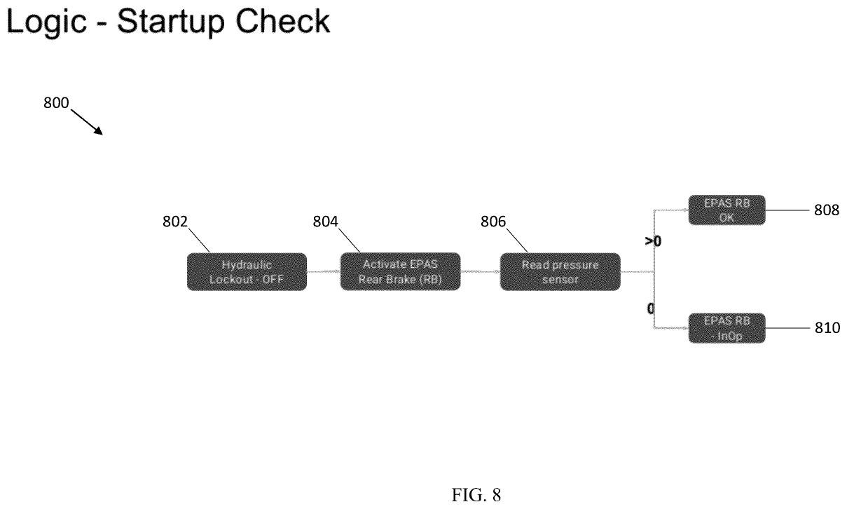

FIG. 8 illustrates a flow chart of an example method 800 of a brake startup operation in a first configuration of the vehicle braking system 600 of FIG. 6, arranged in accordance with at least one embodiment described in the present disclosure. Although illustrated as discrete blocks, various blocks may be divided into additional blocks, combined into fewer blocks, or eliminated, depending on the desired implementation.

In some embodiments, the method 800 may be configured to perform a startup check of a vehicle braking system, including a check on the OEM braking system. For example, upon startup of a vehicle, the vehicle braking system may perform an analysis to verify whether a hydraulic isolator is operational in conjunction with the OEM braking system.

The method 800 may be performed by processing logic that may include hardware (circuitry, dedicated logic, etc.), software (such as is run on a general purpose computer system or a dedicated machine), or a combination of both, which processing logic may be included in the processing unit 210 of FIG. 2, the computing system 1702 of FIG. 17, or another computer system or device. However, another system, or combination of systems, may be used to perform the method 800.

In some embodiments, the method 800 may begin at block 802. At block 802, the processing logic may be configured to disable a hydraulic isolator, such as the hydraulic isolator 660 of FIG. 6. In some embodiments, disabling the hydraulic isolator may enable the OEM braking system to control an OEM caliper in the braking system, such as the OEM caliper 650 of FIG. 6.

At block 804, the processing logic may cause the OEM brake to be applied. For example, the processing logic may transmit a signal to the OEM braking system to apply the OEM brakes.

At block 806, the processing logic may be configured to determine an amount of pressure applied by the OEM braking system. For example, the processing logic may be configured to obtain a sensed pressure value from a pressure sensor (e.g., such as the pressure sensor 640 of FIG. 6).

At block 808, the processing logic may determine that the sensed pressure value is greater than zero, and that the OEM braking system is operational. Alternatively, or additionally, the processing logic may determine the sensed pressure value is greater than a threshold amount, which may indicate the OEM braking system is operational.

At block 810, the processing logic may determine that the sensed pressure value is zero and that the OEM braking system is not operational. Alternatively, or additionally, the processing logic may determine the sensed pressure value is less than a threshold amount, which may indicate the OEM braking system is not operational.

Modifications, additions, or omissions may be made to the method 800 without departing from the scope of the present disclosure. For example, in some embodiments, the method 800 may include any number of other components that may not be explicitly illustrated or described.

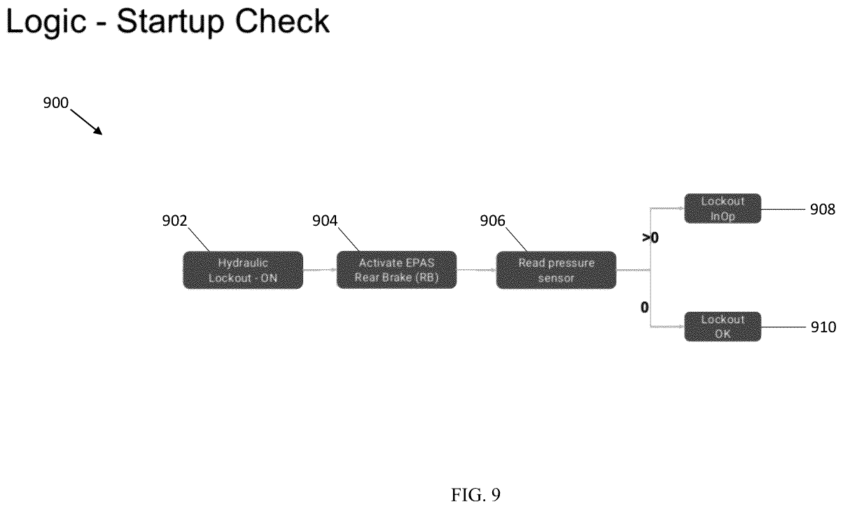

FIG. 9 illustrates a flow chart of an example method 900 of a brake startup operation in a second configuration of the vehicle braking system 600 of FIG. 6, arranged in accordance with at least one embodiment described in the present disclosure. Although illustrated as discrete blocks, various blocks may be divided into additional blocks, combined into fewer blocks, or eliminated, depending on the desired implementation.

In some embodiments, the method 900 may be configured to perform a startup check of a vehicle braking system, including a check on the OEM braking system. For example, upon startup of a vehicle, the vehicle braking system may perform an analysis to verify whether a hydraulic isolator is operational in conjunction with the OEM braking system.

The method 900 may be performed by processing logic that may include hardware (circuitry, dedicated logic, etc.), software (such as is run on a general purpose computer system or a dedicated machine), or a combination of both, which processing logic may be included in the processing unit 210 of FIG. 2, the computing system 1702 of FIG. 17, or another computer system or device. However, another system, or combination of systems, may be used to perform the method 900.

In some embodiments, the method 900 may begin at block 902. At block 902, the processing logic may be configured to enable the hydraulic isolator, such as the hydraulic isolator 660 of FIG. 6. In some embodiments, enabling the hydraulic isolator may disable the OEM braking system from controlling the OEM caliper in the braking system, such as the OEM caliper 650 of FIG. 6.

At block 904, the processing logic may cause the OEM brake to be applied. For example, the processing logic may transmit a signal to the OEM braking system to apply the OEM brakes.

At block 906, the processing logic may be configured to determine an amount of pressure applied by the OEM braking system. For example, the processing logic may be configured to obtain a sensed pressure value from a pressure sensor (e.g., such as the pressure sensor 640 of FIG. 6).

At block 908, the processing logic may determine that the sensed pressure value is greater than zero, which may indicate that the OEM braking system is operational and that the hydraulic isolator is not operational. Alternatively, or additionally, the processing logic may determine the sensed pressure value is greater than a threshold amount, which may indicate the OEM braking system is operational and that the hydraulic isolator is not operational.

At block 910, the processing logic may determine that the sensed pressure value is zero, which may indicate that the OEM braking system is not operational and that the hydraulic isolator is operational. Alternatively, or additionally, the processing logic may determine the sensed pressure value is less than a threshold amount, which may indicate the OEM braking system is not operational and that the hydraulic isolator is operational.

Modifications, additions, or omissions may be made to the method 900 without departing from the scope of the present disclosure. For example, in some embodiments, the method 900 may include any number of other components that may not be explicitly illustrated or described.

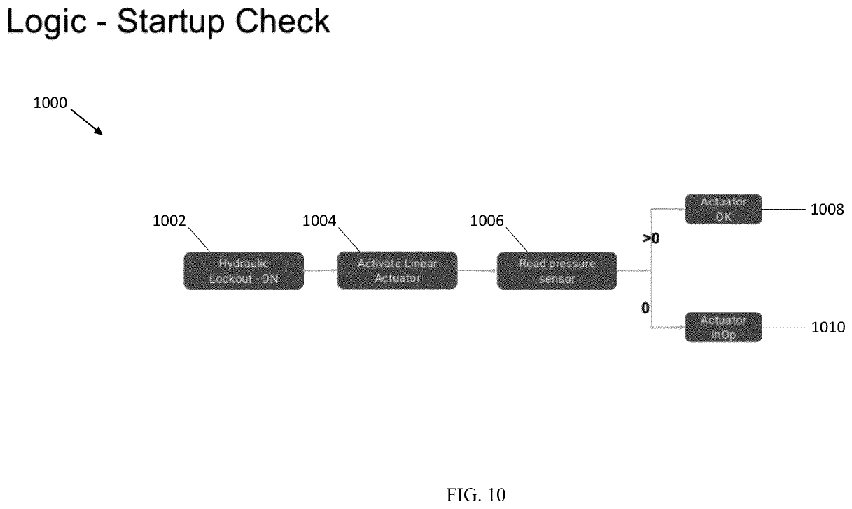

FIG. 10 illustrates a flow chart of an example method 1000 of an actuator startup operation of the vehicle braking system 600 of FIG. 6, arranged in accordance with at least one embodiment described in the present disclosure. Although illustrated as discrete blocks, various blocks may be divided into additional blocks, combined into fewer blocks, or eliminated, depending on the desired implementation.

In some embodiments, the method 1000 may be configured to perform a startup check of a vehicle braking system, including performing a check on the actuator that may be included therein. For example, upon startup of a vehicle, the vehicle braking system may perform an analysis to verify whether the actuator responds to inputs and produces output forces in response to the inputs.

The method 1000 may be performed by processing logic that may include hardware (circuitry, dedicated logic, etc.), software (such as is run on a general purpose computer system or a dedicated machine), or a combination of both, which processing logic may be included in the processing unit 210 of FIG. 2, the computing system 1702 of FIG. 17, or another computer system or device. However, another system, or combination of systems, may be used to perform the method 1000.

In some embodiments, the method 1000 may begin at block 1002. At block 1002, the processing logic may be configured to enable the hydraulic isolator, such as the hydraulic isolator 660 of FIG. 6. In some embodiments, enabling the hydraulic isolator may disable the OEM braking system from controlling the OEM caliper in the braking system, such as the OEM caliper 650 of FIG. 6.

At block 1004, the processing logic may be configured to actuate the actuator. For example, the processing logic may transmit a signal to the actuator that may cause the actuator to apply a force to the emergency brakes.

At block 1006, the processing logic may be configured to determine an amount of pressure applied by the OEM braking system. For example, the processing logic may be configured to obtain a sensed pressure value from a pressure sensor (e.g., such as the pressure sensor 640 of FIG. 6).

At block 1008, the processing logic may determine that the sensed pressure value is greater than zero, and that the actuator is operational. Alternatively, or additionally, the processing logic may determine the sensed pressure value is greater than a threshold amount, which may indicate the actuator is operational.

At block 1010, the processing logic may determine that the sensed pressure value is zero and that the actuator is not operational. Alternatively, or additionally, the processing logic may determine the sensed pressure value is less than a threshold amount, which may indicate the actuator is not operational.

Modifications, additions, or omissions may be made to the method 1000 without departing from the scope of the present disclosure. For example, in some embodiments, the method 1000 may include any number of other components that may not be explicitly illustrated or described.

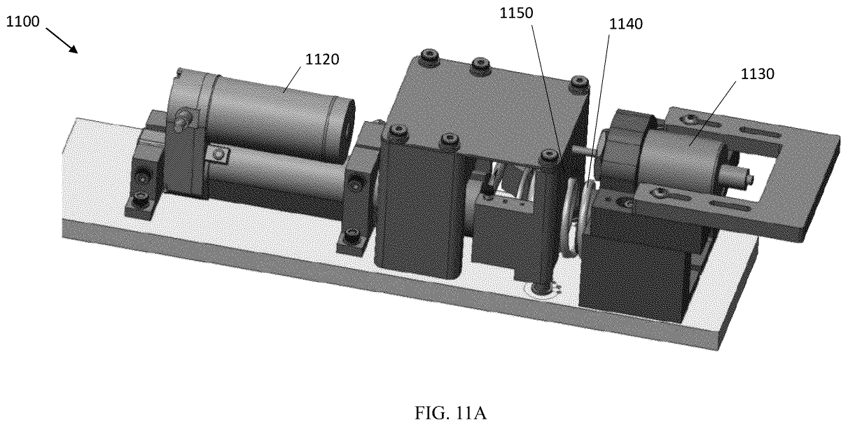

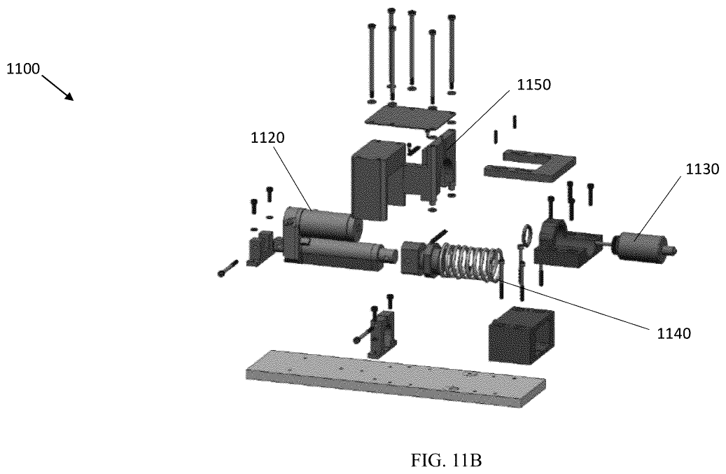

FIG. 11A illustrates an example embodiment of a vehicle braking system 1100 using a spring and that may be included in the vehicle 100 of FIG. 1, in accordance with at least one embodiment described in the present disclosure. The vehicle braking system 1100 may include a linear actuator 1120, a solenoid 1130, a spring 1140, and a latch 1150. In some embodiments, the linear actuator 1120 of the vehicle braking system 1100 may be analogous in structure and/or function to the linear actuator 220 of the vehicle braking system 200 and/or its associated elements.

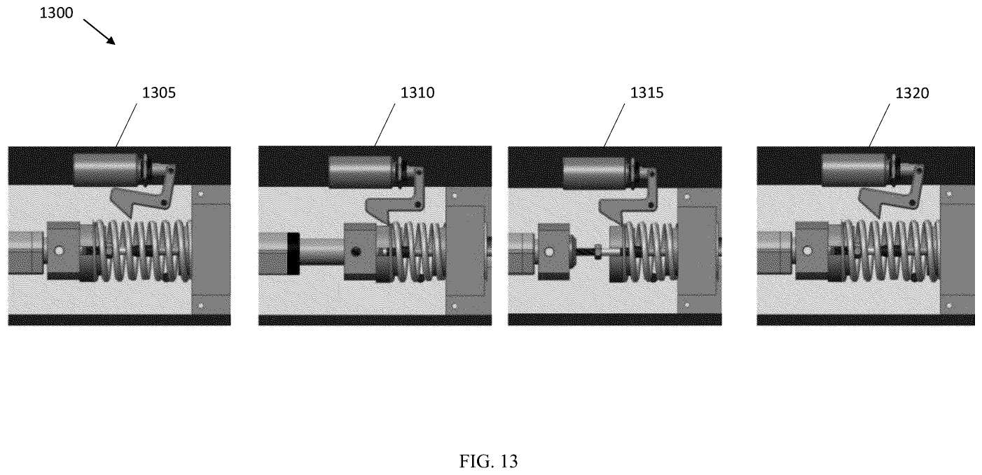

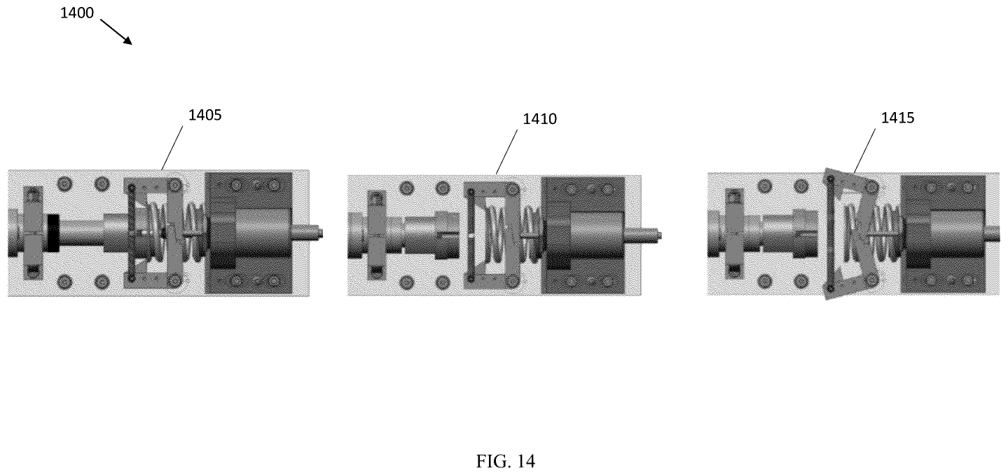

In some embodiments, the vehicle braking system 1100 may be configured to provide braking in an emergency scenario. In some embodiments, the vehicle braking system 1100 may utilize a spring potential to activate an emergency brake in an emergency scenario. For example, upon activation of the linear actuator 1120, such as in response to a parking brake disengaging or the vehicle being placed in drive mode, the linear actuator 1120 may be configured to compress the spring 1140. The spring 1140 may be held in place by the latch 1150, which may be operated by the solenoid 1130. In instances in which an emergency scenario is detected, a signal may be transmitted to the solenoid 1130 which may cause the latch 1150 to release the spring 1140 and engage the emergency brakes. In some embodiments, a cable may include a first end coupled to the spring 1140 and a second end coupled to the emergency brake. In instances in which the spring 1140 is released by the solenoid 1130, the spring 1140 may pull the cable which may actuate the emergency brakes. The different steps that may be associated with the vehicle braking system 1100 may be further illustrated and described in the subsequent figures and associated descriptions. For example, FIGS. 13 and 14 illustrate operations of a vehicle braking system including a double latch and a single latch, respectively. In some embodiments,

In some embodiments, the linear actuator 1120 may be configured to manipulate the spring 1140 and create potential energy in the spring 1140. For example, the spring 1140 may be in a neutral position (e.g., no potential energy stored therein) and the linear actuator 1120 may be configured to compress the spring 1140, which may temporarily create potential energy in the spring 1140. In some embodiments, the solenoid 1130 and the latch 1150 may be used in conjunction with the linear actuator 1120 to store the potential energy in the spring 1140. For example, the solenoid 1130 may receive a signal to activate the latch 1150, which may cause the latch 1150 to engage the spring 1140 after the linear actuator 1120 compresses the spring 1140.

In some embodiments, the solenoid 1130 may be configured to receive signals related to the operation of the latch 1150 in the vehicle braking system 1100. For example, the solenoid 1130 may be configured to activate or deactivate the latch 1150, which may cause the latch 1150 to engage or disengage the spring 1140, respectively. In some embodiments, the solenoid may be communicatively coupled to a processing unit, such as the processing unit 210 of FIG. 2. Additional details related to the operation of a vehicle braking system may be illustrated and/or discussed relative to FIGS. 13 and 14.

In some embodiments, the spring 1140 may be coupled to a first end of a cable, and the second end of the cable may be coupled to the emergency brakes. In some embodiments, the emergency brakes may be the same braking mechanism as the parking brake in a vehicle braking system. In instances in which the spring 1140 is compressed (e.g., by the linear actuator 1120 compressing the spring 1140 and the latch 1150 maintaining the spring 1140 in the compressed state), the cable may be loosened such that the emergency brakes may not be applied. In instances in which the latch 1150 releases the spring 1140, the cable may be pulled by the spring 1140, which may activate the emergency brakes in the vehicle braking system 1100.

In these and other embodiments, in instances in which the emergency brake and/or the parking brake is applied, the spring 1140 may be extended such that the cable may be pulled by the spring 1140 and activate the emergency brake and/or parking brake. For example, in instances in which the parking brake in a vehicle is active, the spring 1140 may be extended such that the cable coupled to the spring 1140 may be pulled and activate the parking and/or emergency brakes.

In portions of this disclosure, the vehicle braking system may be discussed as including a compressible spring that may be used to store potential energy for emergency braking. It will be appreciated by one skilled in the art that the spring in a vehicle braking system may be expandable and used to store potential energy, with some minor adjustments to the other components used in the vehicle braking system.

FIG. 11B illustrates an exploded view of the vehicle braking system 1100 of FIG. 11A, in accordance with at least one embodiment described in the present disclosure. In some embodiments, FIG. 11B illustrates a possible arrangement and/or orientation of the components in the vehicle braking system 1100. For example, the linear actuator 1120 may be proximal to the spring 1140 such that the linear actuator 1120 may be able to compress the spring 1140. Alternatively, or additionally, the linear actuator 1120 may be coupled to a block configured to contact the spring 1140, such that the linear actuator 1120 may push the block which may compress the spring 1140. In some embodiments, the latch 1150 may be positioned relative to the spring 1140 such that the latch 1150 may engage the spring 1140 in instances in which the spring 1140 is compressed. In some embodiments, the solenoid 1130 may be communicatively coupled to the latch 1150 and disposed near the spring 1140 such that the solenoid 1130 may operate the spring 1140 via the latch 1150.

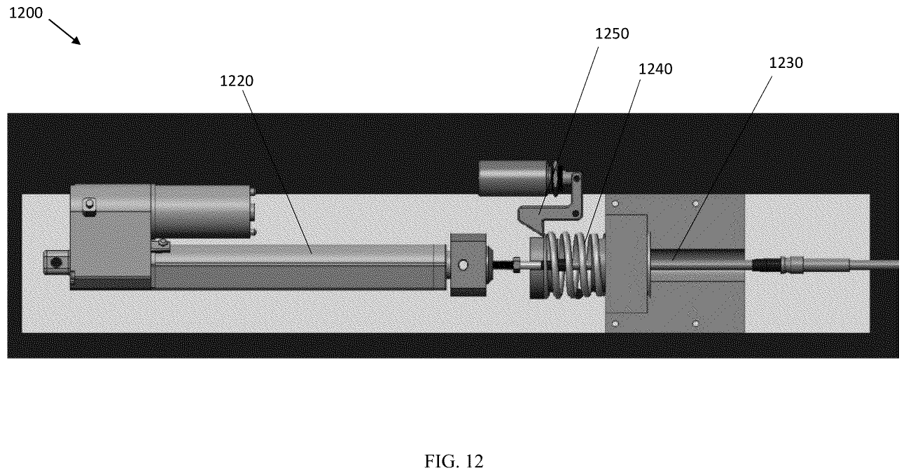

FIG. 12 illustrates an example embodiment of a vehicle braking system 1200 using a single latch and that may be included in the vehicle 100 of FIG. 1, in accordance with at least one embodiment described in the present disclosure. In some embodiments, the vehicle braking system 1200 may be the same or similar as the vehicle braking system 1100 of FIG. 11A. For example, the vehicle braking system 1200 may include a linear actuator 1220, a solenoid 1230, a spring 1240, and a latch 1250. As illustrated, the latch 1250 may include a single latch, such that there may be a single point of contact between the latch 1250 and the spring 1240.

In some embodiments, components of the vehicle braking system 1200 may be similarly arranged and/or oriented with respect to each other as the vehicle braking system 1100. For example, the linear actuator 1220 may be proximal to the spring 1240 and configured to compress the spring 1240 which may create potential energy therein. The latch 1250 may be disposed near a compression point of the spring 1240 such that the latch 1250 may be configured to hold the spring 1240 in a compressed state (e.g., as illustrated in FIG. 12, the latch 1250 is holding the spring 1240 after it has been compressed). The solenoid 1230 may be located near the latch 1250 such that the solenoid 1230 may control operations related to the latch 1250, such as securing the spring 1240 and/or releasing the spring 1240.

FIG. 13 illustrates a sequence of operations 1300 associated with an enlarged portion of the vehicle braking system 1200 of FIG. 12, in accordance with at least one embodiment described in the present disclosure. In a first state 1305, the parking brake may be applied which may correspond to a spring in the vehicle braking system being extended. In some embodiments, the parking brake and the emergency brake in a vehicle braking system may employ the same components in the operations thereof. In the first state 1305, a first end of the spring may extend toward and/or contact the linear actuator and a second end of the spring may contact the solenoid and/or a surface adjacent to the solenoid. In some embodiments, the latch may be disengaged from the spring such that the spring may compress or extend without contacting the latch.

In some embodiments, the linear actuator may be configured to compress the spring which may cause potential energy to be stored within the spring. The second state 1310 may illustrate the linear actuator compressing the spring toward the solenoid.

In some embodiments, the latch may be configured to engage the spring, such as after the spring is compressed by the linear actuator. In some embodiments, the latch engaging the spring may restrain the spring from decompressing, which may cause the spring to store potential energy. The third state 1315 may illustrate the latch engaging the spring in a compressed state. In some embodiments, the linear actuator may retract from the spring once the latch engages the spring. In some embodiments, operation of the latch may be controlled by energizing and deenergizing the solenoid, which may be controlled by a processing unit.

In some embodiments, the solenoid may cause the latch to release from the spring, which may cause the spring to extend and release the potential energy stored therein. For example, in instances in which an emergency is detected, a processing unit may transmit a signal to the solenoid which may cause the latch to be released. The fourth state 1320 may illustrate the latch releasing the spring and the spring extending and releasing the potential energy. In these and other embodiments, the spring releasing the spring potential energy may cause the emergency brakes to be activated.

FIG. 14 illustrates a sequence of operations 1400 associated with a vehicle braking system using a double latch, in accordance with at least one embodiment described in the present disclosure. The operations illustrated in FIG. 14 may be the same or similar as the operations illustrated in FIG. 13. Alternatively, or additionally, the operations of FIG. 14 may be performed with a spring having two points of contact with the spring.

For example, the first state 1405 may be the same or similar as the second state 1310 of FIG. 13. The first state 1405 may illustrate the linear actuator compressing the spring in the direction of the solenoid and generating potential energy within the spring. The second state 1410 may be the same or similar as the third state 1315 of FIG. 13. The second state 1410 may illustrate the spring compressed and held in place by the latch with the linear actuator retracted therefrom. The third state 1415 may be the same or similar as the fourth state 1320 of FIG. 13. The third state 1415 may illustrate the solenoid causing the latch to be released such that the potential energy in the spring may be released. The third state 1415 may occur in instances in which an emergency scenario is detected, and the emergency brake may be deployed.

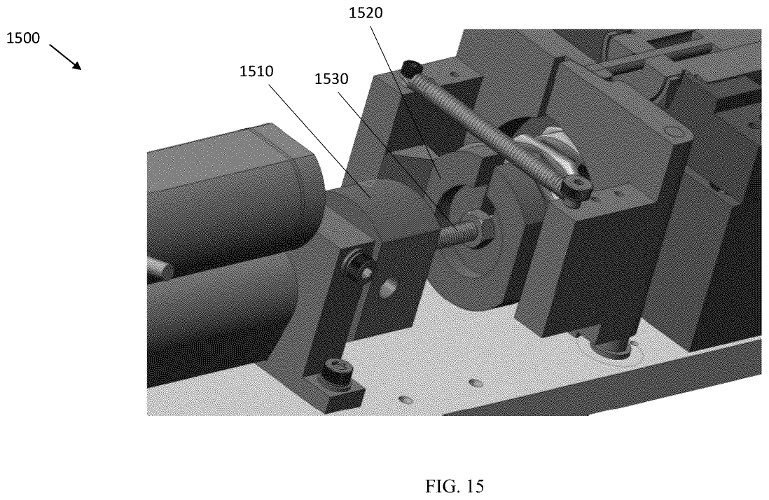

FIG. 15 illustrates an enlarged perspective view of a portion of a vehicle braking system 1500, in accordance with at least one embodiment described in the present disclosure. In some embodiments, a portion of the vehicle braking system 1500 may include a solenoid alignment tip 1510, a spring cap retainer 1520, and a brake cable 1530.

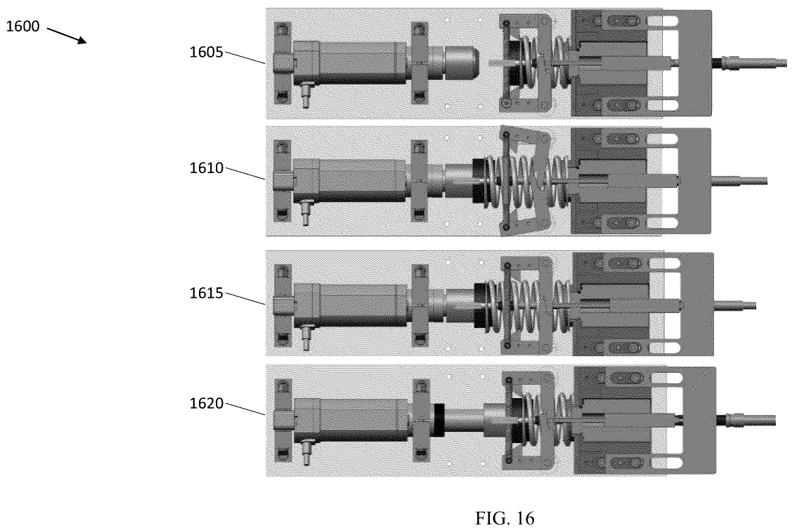

In some embodiments, the solenoid alignment tip 1510 may be coupled to a portion of a linear actuator, such as the linear actuator 1120 of FIGS. 11A and 11B or the linear actuator 1220 of FIG. 12. In some embodiments, the solenoid alignment tip 1510 may be disposed on a lateral most portion of the linear actuator. In some embodiments, the solenoid alignment tip 1510 may include a chamfered edge (the first state 1605 of FIG. 16 illustrates a chamfered edge on the solenoid alignment tip 1510) that may be configured to contribute to the interfacing between the solenoid alignment tip 1510 and the spring cap retainer 1520. For example, the spring cap retainer 1520 may include a receptacle portion that may be configured to receive and/or interface with the chamfered edge of the solenoid alignment tip 1510 such that the solenoid alignment tip 1510 and the spring cap retainer 1520 may be aligned. Alternatively, or additionally, the solenoid alignment tip 1510 may include a beveled edge, a rounded edge, and/or other various shapes or configurations that may be configured to interface with a complementary portion of the spring cap retainer 1520.

In some embodiments, the spring cap retainer 1520 may be coupled to a spring portion of the vehicle braking system 1500, such as the spring 1140 and the spring 1240 of FIGS. 11A and 12, respectively. As described herein, the spring cap retainer 1520 may be configured to interface with the solenoid alignment tip 1510. In some embodiments, the spring cap retainer 1520 may be configured to be coupled to a portion of the brake cable 1530. For example, a distal end of the brake cable 1530 may be coupled to the spring cap retainer 1520, such that extensions and/or retractions in the spring resulting in the movement of the spring cap retainer 1520 may cause the brake cable 1530 to extend or retract and engage or disengage a braking mechanism.

In some embodiments, the brake cable 1530 may include a threaded end. In some embodiments, the threaded end of the brake cable 1530 may extend through the spring cap retainer 1520 and may be secured to the spring cap retainer 1520 by a nut, a clamp, and/or other tightening mechanism. In some embodiments, a tension on the brake cable 1530 may be adjusted by tightening or loosening the tightening mechanisms that secures the brake cable 1530 to the spring cap retainer 1520.

In an alternative to the latching configurations of FIGS. 12 and 13, in some embodiments, a latch, such as the latch 1250 of FIG. 12, may be arranged to latch to the spring cap retainer 1520 as opposed to the spring. In some embodiments, the latch may attach to an outer portion of the spring cap retainer 1520. Alternatively, or additionally, the latch may attach to a portion of the spring cap retainer 1520, such as a lip, a shelf, a notch, a ledge, and/or other similar features.

Modifications, additions, or omissions may be made to the vehicle braking system 1500 without departing from the scope of the present disclosure. For example, in some embodiments, the vehicle braking system 1500 may include any number of other components that may not be explicitly illustrated or described.

FIG. 16 illustrates a sequence of operations 1600 associated with a vehicle braking system using a double latch, in accordance with at least one embodiment described in the present disclosure.

In a first state 1605, the spring may be compressed, and the latch may be closed such that the spring remains in a compressed state. In the first state 1605, the vehicle braking system may be armed and/or ready for deployment, but the brake of the vehicle braking system may not be engaged.

In a second state 1610, the latch may be disengaged and/or released, the spring may be extended, and the brake of the vehicle braking system may be applied. In some embodiments, the second state 1610 may occur in response to the vehicle braking system determining to implement an emergency brake response.

In a third state 1615, the latch may be in an engaged state, and the spring may be extended such that the brake of the vehicle braking system may be applied. The third state 1615 may be similar to the second state 1610 in that the spring may be extended, and the brake may be applied. The third state 1615 may differ from the second state 1610 in the status of the latch, where the latch may be engaged in the third state 1615 and the latch may be disengaged in the second state 1610. In some embodiments, the third state 1615 may illustrate the vehicle braking system in an idle state with the brake applied.

In a fourth state 1620, the latch may be in an engaged state, and the linear actuator may be configured to extend and compress the spring. In response to the spring being compressed by the linear actuator, the brake of the vehicle braking system may be retracted such that the brake is not engaged. In some embodiments, the linear actuator may include a solenoid alignment tip, such as the solenoid alignment tip 1510 of FIG. 15, that may interface with a spring cap retainer 1520 which may push the spring into the compressed position. In some embodiments, once the spring is compressed, the latch may engage the spring cap retainer which may maintain the compression of the spring. Additionally, the linear actuator may be configured to retract upon the latch engaging the spring cap retainer such that the vehicle braking system may armed and/or ready for deployment.

Modifications, additions, or omissions may be made to the operations 1600 without departing from the scope of the present disclosure. For example, in some embodiments, the operations 1600 may include any number of other components that may not be explicitly illustrated or described.

FIG. 17 illustrates a block diagram of an example computing system 1702, according to at least one embodiment of the present disclosure. The computing system 1702 may be configured to implement or direct one or more operations associated with a vehicle braking system (e.g., the processing unit 210 of FIG. 2). The computing system 1702 may include a processor 1750, a memory 1752, and a data storage 1754. The processor 1750, the memory 1752, and the data storage 1754 may be communicatively coupled. The computing system 1702 may include, be included in, or otherwise correspond to other processors or processing units described herein, such as the processing unit 210 of FIG. 2.

In general, the processor 1750 may include any suitable special-purpose or general-purpose computer, computing entity, or processing device including various computer hardware or software modules and may be configured to execute instructions stored on any applicable computer-readable storage media. For example, the processor 1750 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 17, the processor 1750 may include any number of processors configured to, individually or collectively, perform or direct performance of any number of operations described in the present disclosure. Additionally, one or more of the processors may be present on one or more different electronic devices, such as different servers.

In some embodiments, the processor 1750 may be configured to interpret and/or execute program instructions and/or process data stored in the memory 1752, the data storage 1754, or the memory 1752 and the data storage 1754. In some embodiments, the processor 1750 may fetch program instructions from the data storage 1754 and load the program instructions in the memory 1752. After the program instructions are loaded into memory 1752, the processor 1750 may execute the program instructions.

For example, in some embodiments, the modification module may be included in the data storage 1754 as program instructions. The processor 1750 may fetch the program instructions of a corresponding module from the data storage 1754 and may load the program instructions of the corresponding module in the memory 1752. After the program instructions of the corresponding module are loaded into memory 1752, the processor 1750 may execute the program instructions such that the computing system may implement the operations associated with the corresponding module as directed by the instructions.

The memory 1752 and the data storage 1754 may include computer-readable storage media for carrying or having computer-executable instructions or data structures stored thereon. Such computer-readable storage media may include any available media that may be accessed by a general-purpose or special-purpose computer, such as the processor 1750. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 1750 to perform a certain operation or group of operations.

Modifications, additions, or omissions may be made to the computing system 1702 without departing from the scope of the present disclosure. For example, in some embodiments, the computing system 1702 may include any number of other components that may not be explicitly illustrated or described.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.” This interpretation of the phrase “A or B” is still applicable even though the term “A and/or B” may be used at times to include the possibilities of “A” or “B” or “A and B.” All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure. Accordingly, the scope of the invention is intended to be defined only by the claims which follow.

1. A vehicle braking system, comprising:
a processing device configured to receive a heartbeat from an operating vehicle;
a linear actuator communicatively coupled to the processing device;
a master cylinder coupled to the linear actuator; and
a braking caliper,
wherein upon the processing device not receiving the heartbeat within a threshold period of time, the processing device transmitting a signal to the linear actuator to cause a force to be transmitted to the master cylinder, actuating the braking caliper, and causing the operating vehicle to stop.

2. The vehicle braking system of claim 1, further comprising a first power source that is independent from a second power source of the operating vehicle, the first power source operably coupled to the processing device and the linear actuator.

3. The vehicle braking system of claim 1, further comprising a speed sensor coupled to a wheel of the operating vehicle, the speed sensor configured to measure rotational speed of the wheel.

4. The vehicle braking system of claim 1, further comprising a pressure sensor hydraulically coupled between the master cylinder and the braking caliper, the pressure sensor configured to measure a hydraulic pressure between the master cylinder and the braking caliper.

5. The vehicle braking system of claim 1, wherein the operating vehicle includes an original equipment manufacturer (OEM) braking caliper operably coupled to a rotor on a wheel of the operating vehicle and the braking caliper is separate from the OEM braking caliper and operably coupled to the same rotor.

6. The vehicle braking system of claim 1, wherein the braking caliper comprises an original equipment manufacturer (OEM) braking caliper operably coupled to a rotor on a wheel of the operating vehicle, the OEM braking caliper being the only braking caliper operably coupled to the rotor.

7. The vehicle braking system of claim 6, further comprising:
a first hydraulic line operably coupled to the OEM braking caliper; and
a second hydraulic line operably coupled to the OEM braking caliper.

8. The vehicle braking system of claim 7, wherein typical braking functionality including braking responsive to a user depressing a brake pedal or a brake-by-wire signal is provided through the first hydraulic line and emergency braking functionality is provided through the second hydraulic line.

9. The vehicle braking system of claim 7, further comprising a hydraulic isolator disposed in the second hydraulic line to selectively disable hydraulic pressure in the second hydraulic line.

10. A method to operate a vehicle braking system, the method comprising:
monitoring a heartbeat signal from an operating vehicle;
in response to detecting a heartbeat in the heartbeat signal within a threshold amount of time from a prior detected heartbeat, continuing to monitor the heartbeat signal; and
in response to not detecting the heartbeat in the heartbeat signal within the threshold amount of time from the prior detected heartbeat, actuating a braking system of the operating vehicle to slow the operating vehicle.

11. The method of claim 10, wherein actuating the braking system includes:
activating a linear actuator that is operably coupled to a master cylinder to apply a mechanical force to the master cylinder;
converting, in the master cylinder, the mechanical force from the linear actuator to a hydraulic pressure in a hydraulic line operably coupled to a brake caliper; and
applying, via the brake caliper and a rotor coupled to a wheel of the operating vehicle, a braking force in response to the hydraulic pressure in the hydraulic line.

12. The method of claim 11, further comprising, prior to activating the linear actuator:
closing a hydraulic isolator in a second hydraulic line operably coupled to the brake caliper; or
ensuring the hydraulic isolator is closed.

13. The method of claim 11, further comprising:
receiving feedback from the linear actuator that indicates a current state of the linear actuator; and
determining a magnitude of the mechanical force to apply to the master cylinder based on the current state of the linear actuator.

14. The method of claim 11, further comprising:
determining at least one of a rotational speed of the wheel of the operating vehicle or a speed of the operating vehicle; and
determining a magnitude of the mechanical force to apply to the master cylinder based on at least one of the rotational speed of the wheel or the speed of the operating vehicle.

15. The method of claim 10, further comprising triggering the operating vehicle to do at least one of the following in response to not detecting the heartbeat in the heartbeat signal within the threshold amount of time from the prior detected heartbeat:
initiate hazard lights of the operating vehicle;
provide a visual indicator of the actuation of the braking system to an operator of the operating vehicle; or
begin broadcasting a GPS location of the operating vehicle.

16. The method of claim 10, further comprising:
after actuating the braking system, monitoring a rotational speed of a wheel of the operating vehicle to which the braking system is operably coupled; and
in response to determining that the rotational speed of the wheel is zero and that a speed of the operating vehicle is greater than a threshold speed, retracting a linear actuator used to actuate the braking system to reduce a braking force applied to the wheel.

17. The method of claim 16, further comprising:
continuing to monitor the rotational speed of the wheel after retracting the linear actuator; and
in response to determining that the rotational speed of the wheel is non-zero or is above a threshold rotational speed, extending the linear actuator used to actuate the braking system to increase the braking force applied to the wheel.

18. The method of claim 10, wherein actuating the braking system comprises:
signaling a solenoid to release a latch that retains a spring in a compressed state;
the spring actuating at least one of an emergency brake or a parking brake as it decompresses in response to the release of the latch.

19. The method of claim 18, further comprising, prior to signaling the solenoid to release the latch that retains the spring in the compressed state, signaling a linear actuator to compress the spring to the compressed state.
